(19) United States
(12) Patent Application Publication
(10) Pub. No.: US 2012/0282421 A1
(43) Pub. Date: Nov. 8, 2012

(54) METHOD FOR HEATING A FIBER-REINFORCED POLYMER

(75) Inventors: Yasuhiro Akita, Woluwe-ST.-Lambert (BE); Andrew Willett, Etterbeek (BE)

(73) Assignee: TOYOTA MOTOR EUROPE NV/SA, Brussels (BE)

(21) Appl. No.: 13/497,456

(22) PCT Filed: May 4, 2011
(86) PCT No.: PCT/EP11/57164

§ 371 Date: Mar. 21, 2012

(51) Int. Cl. B32B 1/02; H05B 6/46

(52) U.S. Cl. 428/36.4; 264/490

(57) ABSTRACT

The present invention concerns a method for heating a fiber-reinforced polymer forming at least part of a hollow vessel, in particular, a high-pressure gas tank made of a fiber-reinforced polymer, the method comprising the steps of filling said vessel with a flowable polar material, in particular, a flowable polar liquid such as water, and irradiating said vessel with microwaves so as to cause at least a dielectric heating of the flowable polar material within the vessel.

### TECHNICAL FIELD

The disclosure relates to a method for heating a fiber-reinforced thermosetting polymer forming at least part of a vessel, in particular a high-pressure fiber reinforced polymer gas tank.

### BACKGROUND

Composite materials combine two or more distinct materials with complementary qualities, such as for instance lightness and strength. Various composite materials are known to the skilled person. For instance, honeycomb sandwiches, combining a honeycomb core and two facing panels, in metal, polymer and/or other materials, have long been used in a number of different applications, and in particular for structural elements in the aerospace and shipbuilding fields. Other composite materials combine a solid matrix of a first material with reinforcing elements, usually fibers, of a second material embedded in the matrix. Such composite materials include ceramic matrix composites (CMC), metal matrix composites (PMC) and polymer matrix composites (PMC). Advances in various fields, such as nanotechnology, have expanded the use of these materials to many technical fields, such as power generation, construction, medical implants and prostheses, transportation, etc. This has led to further competition to increase the performances and reduce the drawbacks of these materials.

Among composite materials, polymer matrix composites (PMC) and in particular fiber-reinforced polymers (FRP), such as, among others, carbon-, glass- and/or aramid-fiber reinforced polymers are particularly widespread. Fiber-reinforced polymers offer an advantageous combination of the properties, in particular the mechanical properties, of a polymer matrix and reinforcing fibers embedded in said polymer matrix. Both thermosetting and thermoplastic polymers are commonly used as matrices in such fiber-reinforced polymers. To produce a fiber-reinforced thermosetting polymer article, the fibers are first impregnated with a resin, i.e. a prepolymer in a soft solid or viscous state, shaped into a given form, usually by molding, and the resin is then irreversibly hardened by curing. During curing, the prepolymer molecules crosslink with each other to form a three-dimensional network. To initiate or at least accelerate this crosslinking reaction, the resin is usually energized using thermal heat transfer mechanisms and/or electromagnetic excitation. On the other hand, fiber-reinforced thermoplastic polymer composites can be produced by heating a thermoplastic so that it melts and impregnates the reinforcing fibers. The production of fiber-reinforced thermoplastic polymer articles normally involves a heating stage in which the material is heated in order to soften the thermoplastic and enable processes such as forming or handling. Some preforms for fiber-reinforced thermoplastic polymer articles include a so-called comingled fabric in which the reinforcing fibers are mixed with thermoplastics. In this case the impregnation step takes place during forming.

Microwave heating technology is the most promising candidate for curing, drying, thermal treatment, inspection, post-consolidation, repair and a number of other processes for composite materials. A method for heating a fiber-reinforced polymer article using microwaves was disclosed in Japanese patent publication JP H5-79208 B2. According to this first prior art method, the fiber-reinforced polymer article is held in a mold made of a similar material with substantially the same dielectric properties. The mold containing the fiber-reinforced polymer is irradiated with microwaves, whose energy is converted into heat by both the mold and the fiber-reinforced polymer inside it. However, in this method, since the mold absorbs part of the microwave radiation, the dielectric heating of fiber-reinforced polymer article may not be sufficiently homogeneous. In particular, in a thick-walled hollow article such as a pressure tank, the inner layers of the article could be insufficiently heated as a result.

Another method for heating a fiber-reinforced polymer article using microwaves was disclosed in Japanese patent application Laid-Open JP H11-300766 A. According to this second prior art method, the fiber-reinforced polymer article is held in a mold made of a material that is substantially transparent to microwaves. In this method, the dielectric heating by the microwave radiation is substantially limited to the fiber-reinforced polymer, rather than the mold. However, this method also has the potential drawback of insufficiently homogeneous heating, in particular in thick-walled hollow articles.

### SUMMARY

A first object of a method according to the present disclosure is that of more homogeneously heating a fiber-reinforced polymer forming at least part of a hollow vessel.

Accordingly, in a first aspect, a method for heating a fiber-reinforced polymer forming at least part of a hollow vessel comprises the steps of filling said vessel with a flowable polar material and irradiating said vessel with microwaves so as to cause a dielectric heating of at least the flowable polar material within the vessel. Consequently, the vessel is heated from the inside, ensuring a more homogeneous heating. As the polar material inside the vessel is flowable, it can then be extracted again from the vessel after the heating process.

According to a second aspect, the polar material comprises a fluid. This fluid may comprise a gas phase and/or a liquid phase such as, in particular, an aqueous liquid, that is, a liquid comprising water. Other polar liquids such as, for example glycerin, triethylene glycol, acetonitrile, N,N-dimethyl formamide, N-methyl-2-pyrrolidone, and/or ethanol may also be considered. Alternatively or complementarily, however, the polar material may also comprise a granular material, such as, among others, aluminum oxide, calcium oxide, iron oxide, titanium oxide, tungsten oxide and/or zinc oxide. In both cases the introduction and subsequent extraction of the polar material is facilitated. The flowable polar material can also be a combination of a plurality of different flowable materials, including a gas, a liquid and/or a granular material.

According a third aspect, the vessel comprises an impervious inner liner and/or flexible bladder. In particular if the flowable polar material is a fluid, this impervious inner liner and/or flexible bladder will contain the flowable polar material and prevent that it leaks through the vessel and/or contaminates the fiber-reinforced polymer.

According to a fourth aspect, the vessel comprises a pressure relief valve. In particular if the flowable polar material is a fluid, this pressure relief valve will prevent a pressure build-up from a gas phase of the polar material as it heats up.

According to a fifth aspect, said fiber-reinforced polymer comprises electrically conductive fibers, in particular carbon fibers. Resistive heating of the embedded fibers by currents induced by the microwaves will thus contribute to the heating of the fiber-reinforced polymer.

According to a sixth aspect, said vessel is a high-pressure tank.

The fiber-reinforced polymer article may comprise a thermosetting polymer matrix, such as, for example, an epoxy matrix, or a thermoplastic polymer matrix. Accordingly, the heating method may be used, for instance, to cure the thermosetting polymer matrix, or to fuse the thermoplastic polymer matrix with the reinforcing fibers.

The present invention also relates to a hollow vessel at least partially made of a fiber-reinforced thermoset polymer produced with a heating method according to any one of these first to sixth aspects.

The above summary of some example embodiments is not intended to describe each disclosed embodiment or every implementation of the invention. In particular, selected features of any illustrative embodiment within this specification may be incorporated into an additional embodiment unless clearly stated to the contrary.

### BRIEF DESCRIPTION OF THE DRAWING

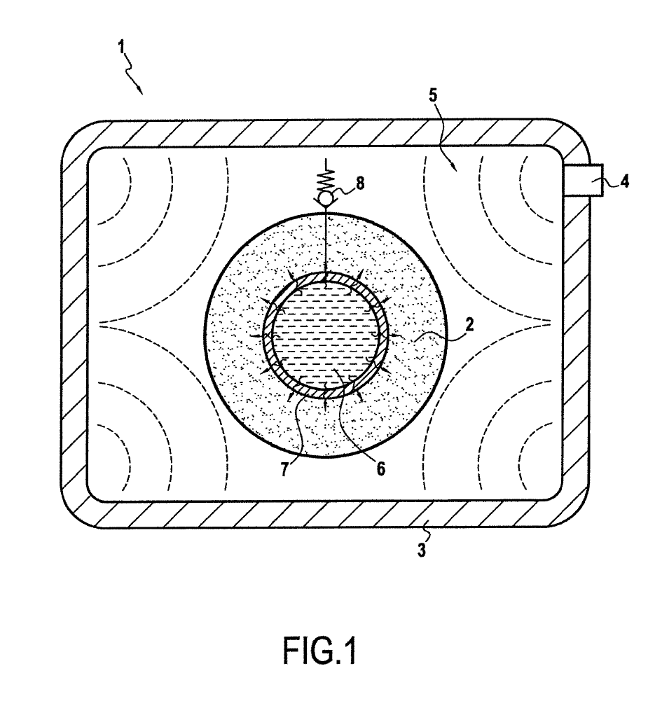

The invention may be more completely understood in consideration of the following detailed description of a embodiments in connection with the accompanying FIG. 1, which is a schematic cut view of a thick-walled high-pressure gas tank made of a carbon-fiber-reinforced polymer during a heating process according to an embodiment of the invention.

While the invention is amenable to various modifications and alternative forms, specifics thereof have been shown by way of example in the drawings and will be described in detail. It should be understood, however, that the intention is not to limit aspects of the invention to the particular embodiments described. On the contrary, the intention is to cover all modifications, equivalents, and alternatives falling within the scope of the invention.

### DETAILED DESCRIPTION

For the following defined terms, these definitions shall be applied, unless a different definition is given in the claims or elsewhere in this specification.

All numeric values are herein assumed to be preceded by the term “about”, whether or not explicitly indicated. The term “about” generally refers to a range of numbers that one of skill in the art would consider equivalent to the recited value (i.e. having the same function or result). In many instances, the term “about” may be indicative as including numbers that are rounded to the nearest significant figure.

Any recitation of numerical ranges by endpoints includes all numbers within that range (e.g., 1 to 5 includes a.o. 1, 4/3, 1.5, 2, e, 2.75, 3, n, 3.80, 4, and 5).

Although some suitable dimension ranges and/or values pertaining to various components, features and/or specifications are disclosed, one of skill in the art, incited by the present disclosure, would understand desired dimensions, ranges and/or values may deviate from those expressly disclosed.

As used in this specification and the appended claims, the singular forms “a”, “an”, and “the” include plural referents unless the content clearly dictates otherwise. As used in this specification and the appended claims, the term “or” is generally employed in its sense including “and/or” unless the content clearly dictates otherwise.

The detailed description and the drawings, which are not necessarily to scale, depict illustrative embodiments and are not intended to limit the scope of the invention. The illustrative embodiments depicted are intended only as exemplary. Selected features of any illustrative embodiment may be incorporated into an additional embodiment unless clearly stated to the contrary.

FIG. 1 shows a cross-section of a microwave heating device 1 containing a thick-walled high-pressure gas tank 2 made of a carbon-fiber-reinforced thermosetting polymer which is being cured using a heating method according to an embodiment of the invention. Such a thick-walled high-pressure gas tank 2 may be formed, for instance, by a filament winding method in which resin-impregnated fibers are wound around a rotating mandrel. The thermosetting polymer may be in particular an epoxy resin, but other types of thermosetting polymers may be considered by the skilled person depending on the circumstances. The microwave curing device 1 comprises an enclosure 3 and a microwave emitter 4, such as a cavity magnetron, which emits microwaves 5, that is, electromagnetic radiation in the 300 MHz-300 GHz frequency range, and preferably in an ISM (industrial, scientific, and medical) frequency band, such as those around 915 MHz and 2.45 GHz. This microwave radiation 5 is substantially confined within the enclosure 3, wherein the thick-walled high-pressure gas tank 2 is also received.

In the illustrated embodiment, the tank 2 has been filled with water 6 in preparation of the curing process. However, an aqueous solution, other polar liquids, a polar gas and/or even a granular material, could be used instead of or in combination with water, depending on circumstances. Even though the thermosetting polymer is not yet cured, the stiffness of the reinforcement fibers and the comparative thickness of the tank walls help maintain the shape of the water-filled tank 2 before and during the curing process. A liquid-impervious liner 7 within the tank 2 separates the water 6 from the carbon-fiber-reinforced thermosetting polymer forming the walls of the tank 2, preventing contamination of the thermosetting polymer by the water 6. This liner 7 can be, for instance, a thermoplastic film with or without a layer of metal, such as, for example aluminum, copper, titanium, or tungsten, sufficiently thin not to significantly shield the water 6 from the microwave radiation 5. While in the illustrated embodiment the water containment is achieved with a liner, that is, a membrane adjacent to the inner wall of the tank 2, a loose membrane forming a flexible bladder may also be used for this purpose, alternatively to, or in combination with, the liner 7.

The tank 2 has also been connected to a pressure relief valve 8, to vent water vapor in case of an excessive pressure build-up within the tank 2 during the curing process. With the pressure relief valve 8 inside the enclosure 3, as shown in FIG. 1, the pressure relief valve 8 can preferably be in materials such as a polymer, glass, a ceramic and/or aluminum which are not significantly affected by the microwave radiation 5. Alternatively, however, the tank 2 may be connected through a duct to a pressure relief valve outside the enclosure 3.

During the curing process, the microwave radiation 5 causes dielectric heating of the water 6, raising the temperature within the tank 2 and heating up the thermosetting polymer from within the tank 2. Simultaneously, the microwave radiation 5 also directly heats up the tank 2 itself, both through dielectric heating of the thermosetting polymer matrix and through resistive heating of the reinforcing embedded carbon fibers by induced currents.

The absorption of electromagnetic radiation and its conversion into heat in a given material depends from its so-called dielectric loss factor εᵣ′, that is, the product of the relative dielectric constant εᵣ′ of the material and the tangent of its dielectric loss angle δ, at the frequency of the electromagnetic radiation, and this according to the following equation:

P_{d}=ωE²ε₀εᵣ″=ωE²ε₀εᵣ′ tan δ

wherein P_{d} represents the dissipated power, ω the angular frequency of the electromagnetic radiation, E the electrical field strength and ε₀ the permittivity of free space (approximately 8.854·10⁻¹² F/m).

Because of this absorption, the electromagnetic radiation is attenuated as it travels through the material. This attenuation a follows this second equation:

$$α = \frac{ω}{c} \sqrt{\frac{{ɛ}_{r}^{′} ( \sqrt{1 + {tan}^{2} δ} - 1 )}{2}}$$

wherein c represents the speed of light. Since tan δ<<1, the attenuation α can also be approximated as:

$$α \approx \frac{ω \sqrt{{ɛ}_{r}^{′}} tan δ}{2 c}$$

Although the thick-walled tank 2 absorbs a significant part of the incoming microwave radiation, and thus substantially attenuates this microwave radiation before it reaches the water 6 inside the tank 2, a significantly higher dielectric loss factor of water compared with that of the fiber-reinforced thermosetting polymer material of the tank 2 results in a substantial heat generation in the water 6 within the tank 2.

The tank 2 is thus rapidly heated up throughout its entire thickness, even when this thickness is significant, for example more than 50 mm, by both direct microwave dissipation of the fiber-reinforced thermosetting polymer material and heat conduction from the water 6, to a predetermined curing temperature. This curing temperature can thus be maintained during a predetermined curing period by intermittent or low-power microwave radiation. Eventually, depending on the specifications of the thermosetting polymer, the curing process may comprise several curing stages, with different curing temperatures and periods.

After the tank 2 has been cured, it can then be removed from the enclosure 3 and emptied from the water 6 to make it ready for use.

While in this first embodiment the polymer matrix of the fiber-reinforced polymer article to be heated is a thermosetting polymer matrix, and the purpose of heating the fiber-reinforced polymer article is to cure this thermosetting polymer, in an alternative embodiment this heating method may be used to heat a fiber-reinforced polymer article with a thermoplastic polymer matrix. This may be done with the purpose of fusing the thermoplastic polymer matrix to the reinforcing fibers. For instance, the article may have been formed by winding around a mandrel the reinforcing fibers together with strands of the thermoplastic polymer that is to form the polymer matrix. By heating the article, the strands of thermoplastic polymer will at least partially melt and flow, fusing around the reinforcing fibers and with them to form a continuous or nearly continuous matrix in which the reinforcing fibers will be embedded.

Those skilled in the art will recognize that the present invention may be manifested in a variety of forms other than the specific embodiments described and contemplated herein. For instance, other reinforcing fibers other than carbon fibers may be used, such as, for instance, glass fibers, polyamide fibers, polyethylene fibers, aramid fibers, etc. Accordingly, departure in form and detail may be made without departing from the scope of the present invention as described in the appended claims.

1. A method for heating for heating a fiber-reinforced polymer forming at least part of a hollow vessel, comprising the steps of:
filling said vessel with a flowable polar material; and
irradiating said vessel with microwaves so as to cause at least a dielectric heating of the flowable polar material within the vessel.

2. The method according to claim 1, wherein the flowable polar material comprises a fluid.

3. The method according to claim 2, wherein said fluid comprises a liquid phase.

4. The method according to claim 3, wherein said liquid phase comprises water.

5. The method according to claim 2, wherein said fluid comprises a gas phase.

6. The method according to claim 2, wherein said vessel comprises an impervious inner line.

7. The method according to claim 2, wherein said vessel comprises an impervious flexible bladder.

8. The method according to claim 2, wherein said vessel is connected to a pressure relief valve.

9. The method according to claim 1, wherein the flowable polar material comprises a granular material.

10. The method according to claim 1, wherein said fiber-reinforced polymer comprises electrically conductive fibers.

11. The method according to claim 10, wherein said electrically conductive fibers comprises carbon fibers.

12. The method according to claim 1, wherein said fiber-reinforced polymer comprises a thermosetting polymer matrix, such as, for example, an epoxy matrix.

13. The method according to claim 1, wherein said fiber-reinforced polymer comprises a thermoplastic polymer matrix.

14. The method according to claim 1, wherein said vessel is a high-pressure gas tank.

15. A hollow vessel at least partially made of a fiber-reinforce thermoset polymer heated using the method according to claim 1.
